(19) United States
(12) Patent Application Publication
(10) Pub. No.: US 2007/0186551 A1
(43) Pub. Date: Aug. 16, 2007

(54) Exhaust-gas turbocharger

(76) Inventors: Johannes Ante, Regensburg (DE); Markus Gilch, Mauern (DE); Fernando-Monge Villalobos, Regensburg (DE)

Correspondence Address: COHEN, PONTANI, LIEBERMAN & PAVANE, 551 FIFTH AVENUE, SUITE 1210, NEW YORK, NY, 10176, US

(21) Appl. No.: 11/632,080

(22) PCT Filed: Jun. 16, 2005
(86) PCT No.: PCT/EP05/52796

§ 371 Date: Jan. 9, 2007

(30) Foreign Application Priority Data
Jul. 15, 2004 (DE) 10 2004 03 512.0
Mar. 9, 2005 (DE) 10 2005 010 921.7

(51) Int. Cl. F02B 33/44

(52) U.S. Cl. 60/605.1

(57) ABSTRACT

The invention relates to an exhaust-gas turbocharger (1) for an internal combustion engine, said turbocharger comprising a device (26) for detecting the speed of the turbocharger shaft (5). The device (26) for detecting the speed comprises an element (21) for varying a magnetic field, which is located on and/or in the end (10) of the turbocharger shaft (5) that is on the compressor side, said variation of the magnetic field (25) taking place in accordance with the rotation of the turbocharger shaft (5). A sensor element (19) is provided in the vicinity of the element (21) for varying the magnetic field (25), said sensor element detecting the variation in the magnetic field and converting it into electric signals that can be evaluated.

The invention relates to an exhaust-gas turbocharger for an internal combustion engine, comprising a compressor and a turbine, a compressor wheel being rotatably mounted in the compressor and a turbine wheel being rotatably mounted in the turbine, and the compressor wheel being mechanically connected to the turbine wheel by means of a rotatably mounted turbocharger shaft, and the exhaust-gas turbocharger having a device for detecting the speed of the turbocharger shaft.

The output produced by an internal combustion engine depends on the air mass and the corresponding fuel quantity which can be made available to the machine for combustion. If it is intended to increase the output of the internal combustion engine, more combustion air and more fuel must be supplied. This increase in output is achieved in a naturally aspirated engine by an increase in the swept volume or by an increase in the speed. However, an increase in the swept volume leads in principle to heavier internal combustion engines which are of larger dimensions and thus more expensive. The increase in the speed entails considerable problems and disadvantages especially in larger internal combustion engines and is limited for technical reasons.

A technical solution often used for increasing the output of an internal combustion engine is supercharging. This refers to the pre-compression of the combustion air by an exhaust-gas turbocharger or also by means of a compressor mechanically driven by the engine. An exhaust-gas turbocharger essentially comprises a turbo compressor and a turbine which are connected to a common shaft and rotate at the same speed. The turbine converts the normally wasted energy of the exhaust gas into rotary energy and drives the compressor. The compressor draws in fresh air and delivers the pre-compressed air to the individual cylinders of the engine. An increased fuel quantity can be fed to the larger air quantity in the cylinders, as a result of which the internal combustion engine delivers more output. In addition, the combustion process is favorably influenced, so that the internal combustion engine achieves a better overall efficiency. In addition, the torque characteristic of an internal combustion engine supercharged with a turbocharger can be designed to be extremely favorable. Naturally aspirated production engines at vehicle manufacturers can be substantially optimized by the use of an exhaust-gas turbocharger without any significant design alterations to the internal combustion engine. As a rule, supercharged internal combustion engines have a lower specific fuel consumption and lower pollutant emission. In addition, turbocharged engines are as a rule quieter than naturally aspirated engines of the same output, since the exhaust-gas turbocharger itself acts like an additional silencer. In internal combustion engines having a large operating speed range, for example in internal combustion engines for passenger cars, a high charge pressure is required even at low engine speeds. For this purpose, a charge-pressure control valve, what is referred to as a wastegate valve, is introduced in these turbochargers. By the selection of a corresponding turbine casing, a high charge pressure is built up rapidly even at low engine speeds. The charge-pressure control valve (wastegate valve) then limits the charge pressure to a constant value as the engine speed increases. Alternatively, turbochargers having a variable turbine geometry (VTG) are used.

At increasing exhaust-gas quantity, the maximum permissible speed of the combination of turbine wheel and turbocharger shaft, which is also referred to as the rotor assembly of the turbocharger, may be exceeded. If the speed of the rotor assembly is exceeded to an inadmissible degree, said rotor assembly would be destroyed, which is tantamount to a total loss of the turbocharger. Especially modern and small turbochargers with markedly smaller diameters of turbine wheel and compressor wheel, which have an improved angular acceleration behavior due to a considerably smaller mass moment of inertia, are affected by the problem of the speed exceeding the maximum admissible value. Depending on the design of the turbocharger, complete destruction of the turbocharger results if the speed limit is exceeded just by about 5%.

Charge-pressure control valves which are activated according to the prior art by a signal resulting from the charge pressure produced have proved successful for limiting the speed. If the charge pressure exceeds a predetermined threshold value, the charge-pressure control valve opens and directs some of the exhaust-gas mass flow past the turbine. The latter consumes less power on account of the reduced mass flow, and the compressor output decreases to the same extent. The charge pressure and the speed of the turbine wheel and of the compressor wheel are reduced. However, this control is relatively sluggish, since the pressure build-up takes place with a time delay in the event of overspeeding of the rotor assembly. Therefore the speed control for the turbocharger must intervene with the charge pressure monitoring in the highly dynamic range (load alternation) by correspondingly early reduction of the charge pressure, which leads to a loss of efficiency.

Direct measurement of the speed at the compressor wheel or at the turbine wheel turns out to be difficult, since, for example, the turbine wheel is subjected to extreme thermal loading (up to 1000° C.), which prevents a speed measurement using conventional methods at the turbine wheel. In a publication of acam messelectronic GmbH dated April 2001, it is proposed to measure the compressor blade impulses by the eddy current principle and in this way determine the speed of the compressor wheel. This method is complicated and expensive, since at least one eddy current sensor would have to be integrated in the housing of the compressor, which would probably be extremely difficult on account of the high precision with which the components of a turbocharger are produced. In addition to the precise integration of the eddy current sensor in the compressor casing, sealing problems arise which, on account of the high thermal loading of a turbocharger, can be overcome only by elaborate alterations to the design of the turbocharger.

The object of the present invention is therefore to specify an exhaust-gas turbocharger for an internal combustion engine in which the speed of the rotating parts (turbine wheel, compressor wheel, turbocharger shaft) can be detected in a simple and cost-effective manner without making substantial structural alterations to the design of existing turbochargers.

This object is achieved according to the invention in that the device for detecting the speed has an element for varying a magnetic field on the and/or in the compressor-side end of the turbocharger shaft, the variation in the magnetic field being effected in relation to the speed of the turbocharger shaft, and a sensor element being arranged in the vicinity of the element for varying the magnetic field, said sensor element detecting the variation in the magnetic field and converting it into signals that can be evaluated electrically.

An advantage with the arrangement of the element on the and/or in the compressor-side end of the turbocharger shaft is that this region of the turbocharger is subjected to relatively low thermal loading, since it is at a considerable distance from the hot exhaust-gas flow and is cooled by the flow of fresh air. In addition, the compressor-side end of the turbocharger shaft is readily accessible, as a result of which commercially available sensor elements, such as, for example, Hall sensor elements, magneto-resistive sensor elements or inductive sensor elements, can be placed here without alterations to or with only slight alterations to the design of existing turbochargers, which makes possible a cost-effective speed measurement in the turbocharger. With the signal generated by the sensor element, the charge-pressure control valve can be activated very quickly and precisely or the turbine geometry of VTG chargers can be changed very quickly and precisely in order to avoid exceeding the speed of the rotor assembly. The turbocharger can therefore always be operated very close to its speed limit, as a result of which it achieves its maximum efficiency. A relatively large safety margin relative to the maximum speed limit, as is normal practice in pressure-controlled turbochargers, is not required.

In a first development, the sensor element is designed as a Hall sensor element. Hall sensors are very suitable for detecting the variation in a magnetic field and can therefore be used very effectively for the speed detection. Hall sensors can be purchased commercially at very low cost and they can also be used at temperatures up to about 160° C.

Alternatively, the sensor element is designed as a magneto-resistive (MR) sensor element. MR sensor elements are in turn readily suitable for detecting the variation in a magnetic field and can be purchased commercially at low cost.

In a next alternative configuration, the sensor element is designed as an inductive sensor element. Inductive sensor elements are also most suitable for detecting the variation in a magnetic field.

In a next configuration, the sensor element is arranged in the axial extension of the turbocharger shaft. In this arrangement of the sensor element, the air flow in the air inlet of the compressor is only impaired to a very small extent by the sensor element itself. The efficiency of the turbocharger is fully maintained as a result.

Alternatively, the sensor element is arranged next to the compressor-side end of the turbocharger shaft. In this configuration, the variation in the magnetic field produced by a bar magnet arranged in the compressor-side end of the turbocharger shaft can be detected especially effectively, since the poles of the bar magnet move past the sensor element one after the other.

In one configuration of the invention, the sensor element is integrated in a sensor which is connected to an adapter via a distance piece, it being possible for the adapter to be mounted on the air inlet of the compressor casing. Through the use of an adapter, no structural changes at all are necessary at the compressor casing in order to realize the speed detection in the turbocharger. This is a decisive advantage in particular with regard to the complicated design of compressor casings.

Alternatively, the sensor element is integrated in a sensor which together with a distance piece forms a plug-in finger which can be plugged into the air inlet through an aperture in the compressor casing. Such a plug-in finger forms a very compact component which reduces the cross section of the air inlet only slightly. The fitting of such a plug-in finger in an aperture in the compressor casing turns out to be very simple, which in particular is a great advantage when mounting the sensor element on the turbocharger.

According to a next alternative embodiment, the sensor element is integrated in a sensor which can be mounted on the outer wall of the compressor casing in the region of the air inlet. In this embodiment there is no need to interfere in any way with the compressor casing or the air inlet of the turbocharger. The cross section of the air inlet is fully retained and no undesirable effects can be caused in the air flow in front of the compressor wheel by the sensor element or the sensor. For example, a powerful magnet which is arranged in the compressor-side end of the turbocharger shaft produces a sufficiently pronounced variation in the magnetic field in the sensor element arranged on the outer wall of the compressor casing during the rotation of the turbocharger shaft, so that an electric signal corresponding to the speed of the turbocharger shaft can be generated in this sensor.

In a next configuration, the element for varying a magnetic field is designed as a bar magnet. A diametrically polarized bar magnet rotating with the turbocharger shaft produces in its surroundings a readily measurable variation in the magnetic field, whereby the speed of the turbocharger shaft, of the compressor wheel and of the turbine wheel can be readily detected.

Alternatively, the element for varying a magnetic field is designed in the form of two magnetic dipoles, the north pole of the first dipole facing the south pole of the second dipole.

Two magnetic dipoles perform the same function as a bar magnet; however, they are lighter than a bar magnet, a factor which is very advantageous.

In a next alternative embodiment, the element for varying a magnetic field is designed as a nut of ferromagnetic material. As a rule, the rotor assembly (turbocharger shaft and turbine wheel) is in any case connected to the compressor wheel by means of a nut. If this nut is made of ferromagnetic material, it is able on account of its geometrical form to vary a magnetic field when it is rotated in the latter. Due to this embodiment, the variation in the magnetic field is effected by a component which is present in the turbocharger in any case.

If the nut is permanently magnetized, it at the same time produces the magnetic field, which during its rotation varies in the sensor element. Such multiple functions of a component are to be considered very advantageous for cost reasons.

In a next configuration of the invention, the element for varying a magnetic field is designed as a slot in the compressor-side end of the turbocharger shaft. With a slot in a ferromagnetic material, a magnetic field applied from outside can be readily varied. The magnetic flux is directed in accordance with the slot rotating in the field. This simple and cost-effective measure leads to a readily measurable variation in the magnetic field in the sensor element.

In a development of the invention, at least one flux-concentrating body is arranged in such a way that it collects the magnetic flux of the magnetic field and directs it toward the sensor element. With the use of a flux-concentrating body, the sensor element may also be arranged relatively far away from the element for varying the magnetic field. Due to the flux-collecting body, a sufficiently powerful magnetic flux is directed through the sensor element, so that an electrical signal that can be readily utilized is produced in the sensor. Distances of 2 to 10 cm between the element for varying the magnetic field and the sensor element can be easily bridged with flux-concentrating bodies. Thus, even in large turbochargers having an air inlet of large area, the sensor element can be arranged on the outside on the compressor casing, a factor which is especially favorable, since in this arrangement the sensor can easily be exchanged in the event of a repair.

In a next development, the element for varying the magnetic field and the sensor element are surrounded by a magnetic screen, which screens the element for varying the magnetic field and the sensor element from external magnetic disturbance fields. Magnetic fields produced outside the turbocharger may lead to incorrect speed measurements in the turbocharger. The magnetic screen keeps these disturbance fields away from the element for varying the magnetic field and away from the sensor element, thereby helping to achieve a perfect measurement.

In addition, it is advantageous if the element for varying the magnetic field, the sensor element and the flux-concentrating body are surrounded by the magnetic screen, which screens the element for varying the magnetic field, the sensor element and the flux-concentrating body from external magnetic disturbance fields. Magnetic disturbance fields may also spread into the flux-concentrating body, which is prevented by the screen.

In one configuration, part of the compressor casing is designed as a magnetic screen. In this way, the compressor casing assumes another function, which saves costs, material and weight. There are similar advantages if part of the flux-concentrating body is designed as a magnetic screen. In both cases, production of the system is considerably facilitated.

In a next development, the sensor element and/or the flux-concentrating body are/is integrated in a fastening system for an intake hose. The fastening system may be designed, for example, as a hose clip. If the fastening system accommodates the sensor element and/or the flux-concentrating body, these components are very simple to mount. This development also saves costs and construction space.

It is also advantageous if the flux-concentrating body and/or the magnetic screen and/or the sensor element and/or the magnetic field sensor and/or the connector housing and/or the fastening system are/is entirely or partly encapsulated in plastic. This results in production advantages and the encapsulated components are effectively protected from environmental effects.

Embodiments of the invention are shown by way of example in the figures. In the drawing:

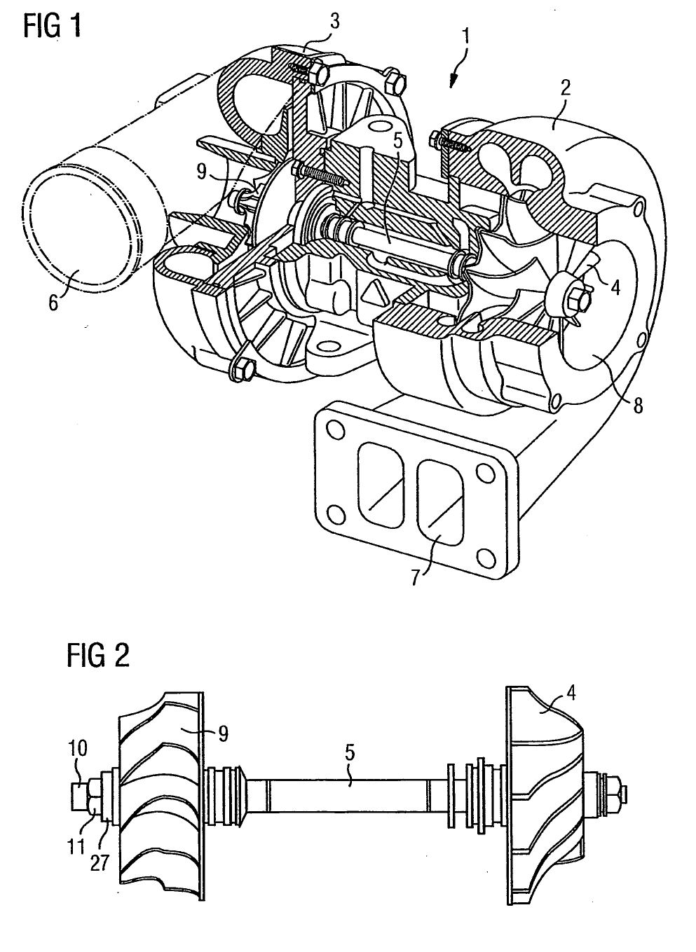

FIG. 1 shows a conventional exhaust-gas turbocharger,

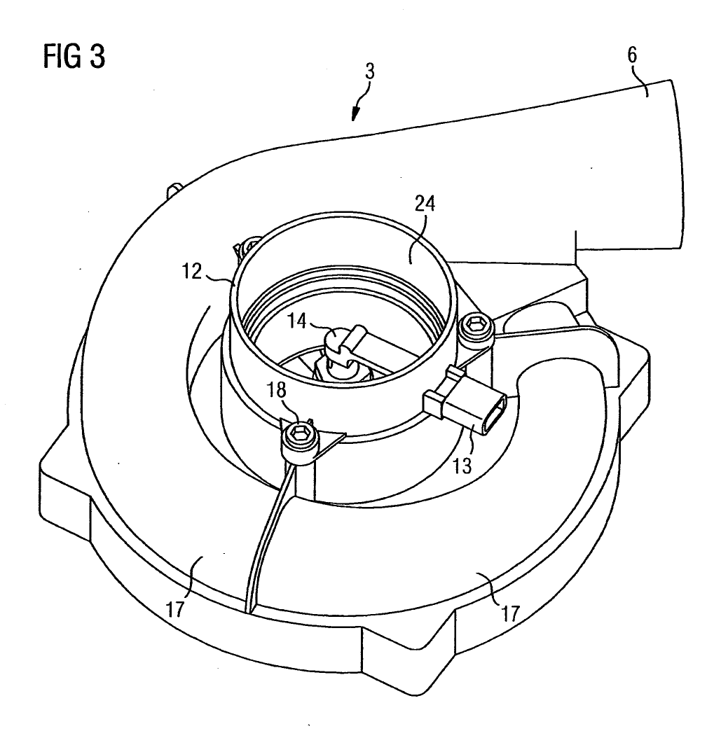

FIG. 2 shows the turbine wheel, the turbocharger shaft and the compressor wheel,

FIG. 3 shows a compressor with an air inlet and an air outlet,

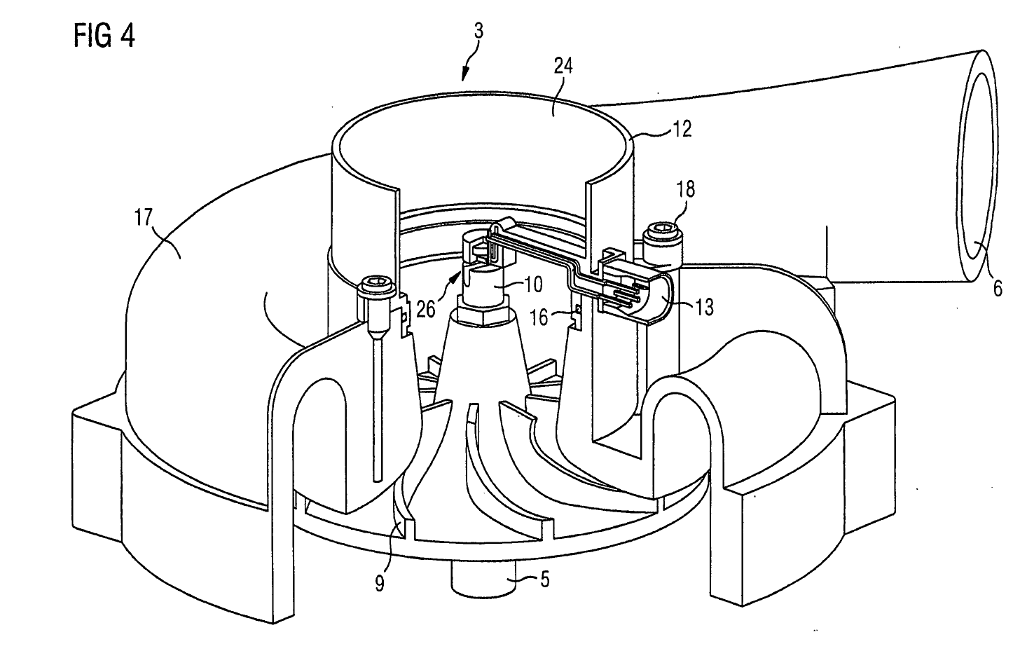

FIG. 4 shows the compressor shown in FIG. 3 as a partial section,

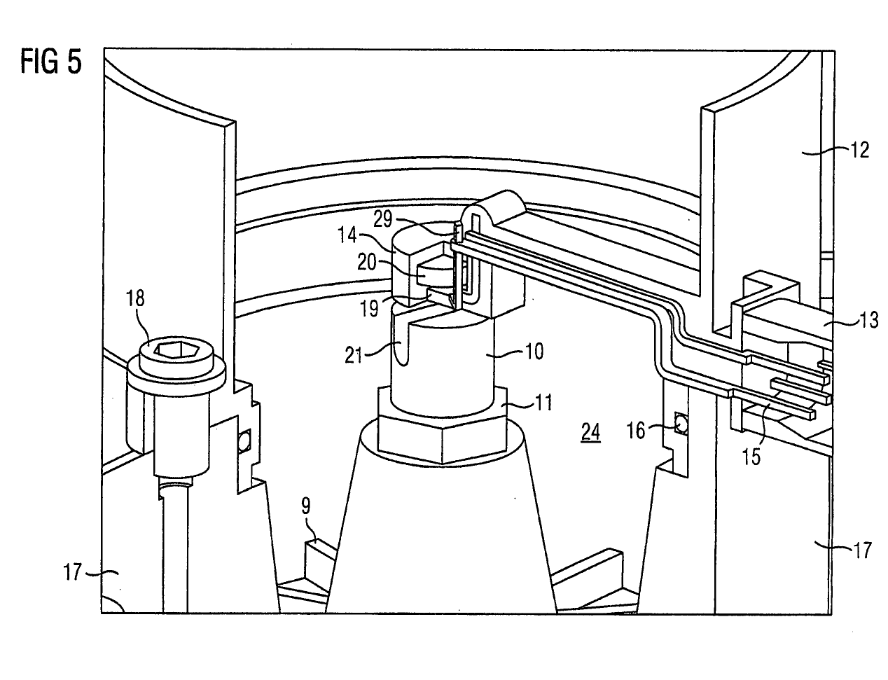

FIG. 5 shows the adapter,

FIG. 6 shows a more detailed illustration of the adapter from FIG. 5,

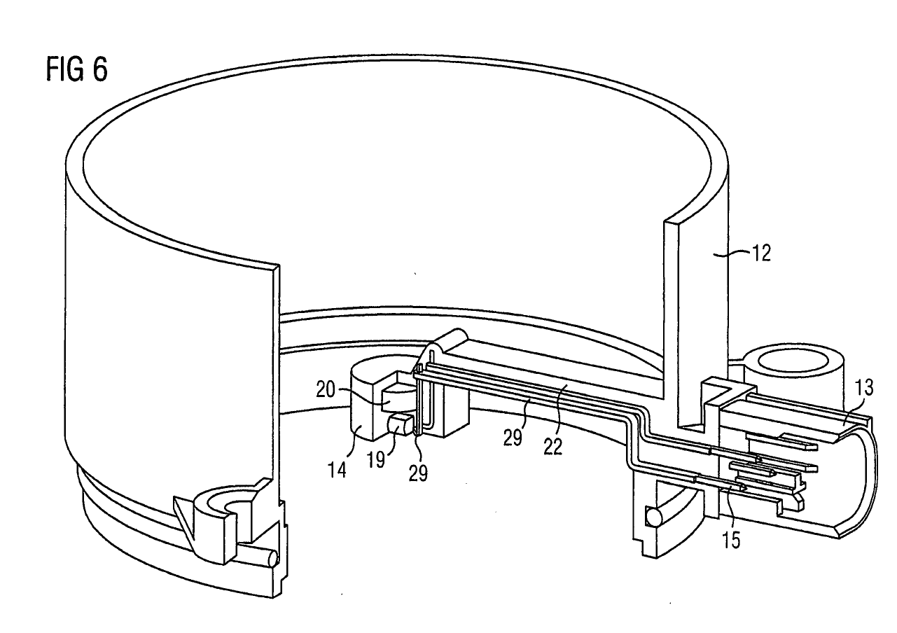

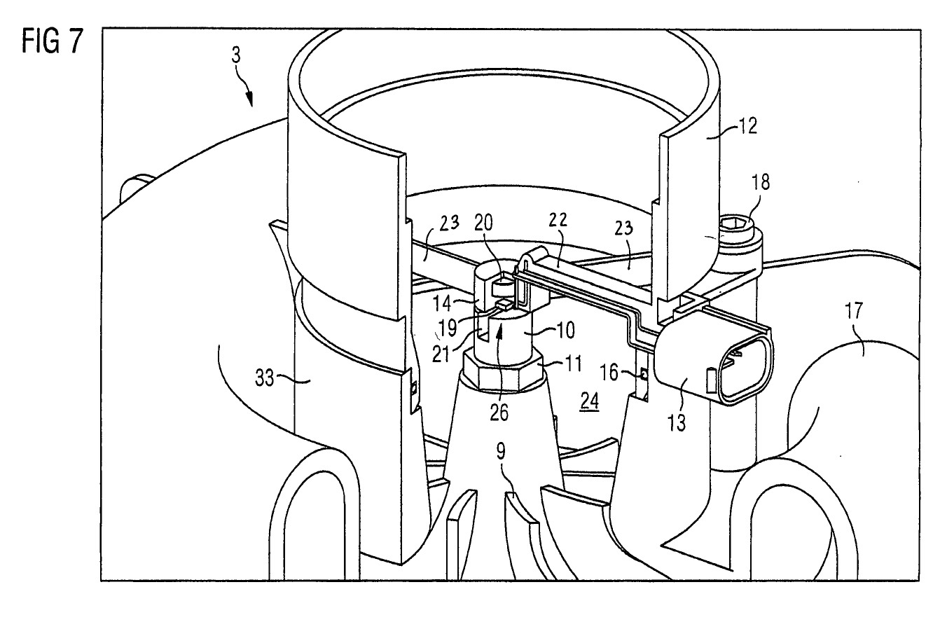

FIG. 7 shows improved retention of the magnetic field sensor,

FIG. 8 shows a partial section of the adapter known from FIG. 7,

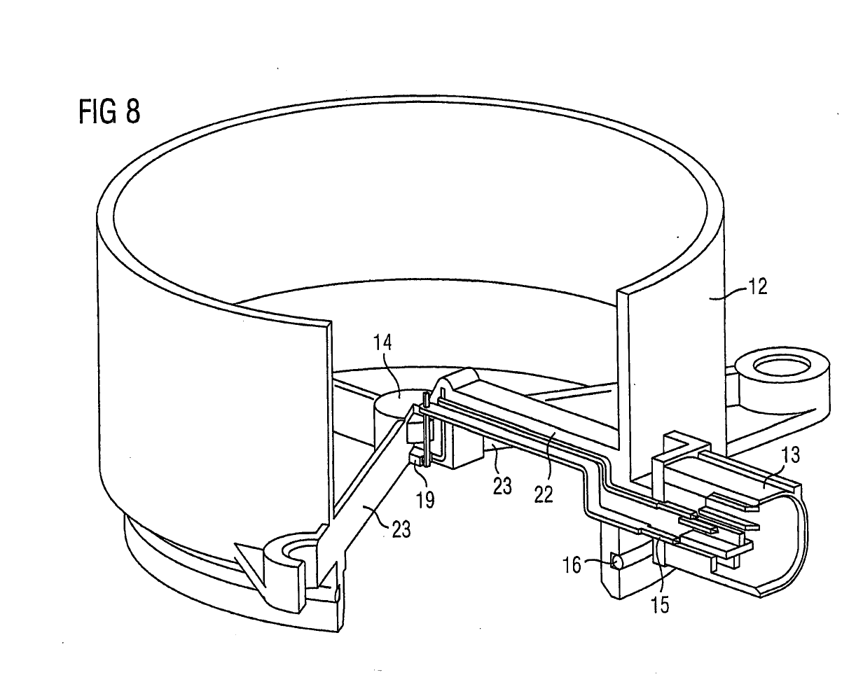

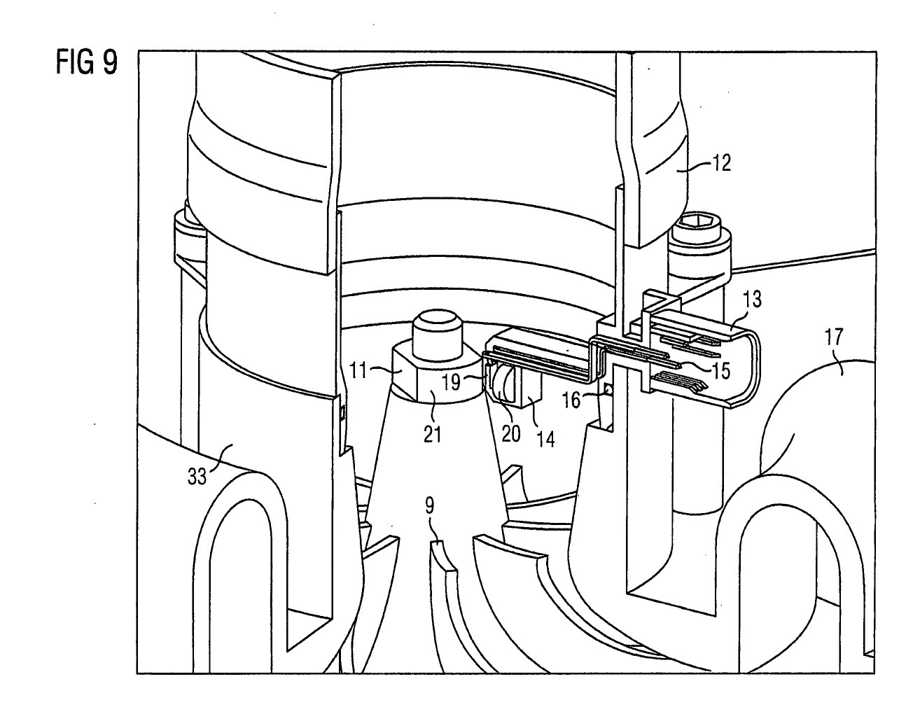

FIG. 9 shows a further possible embodiment of the invention,

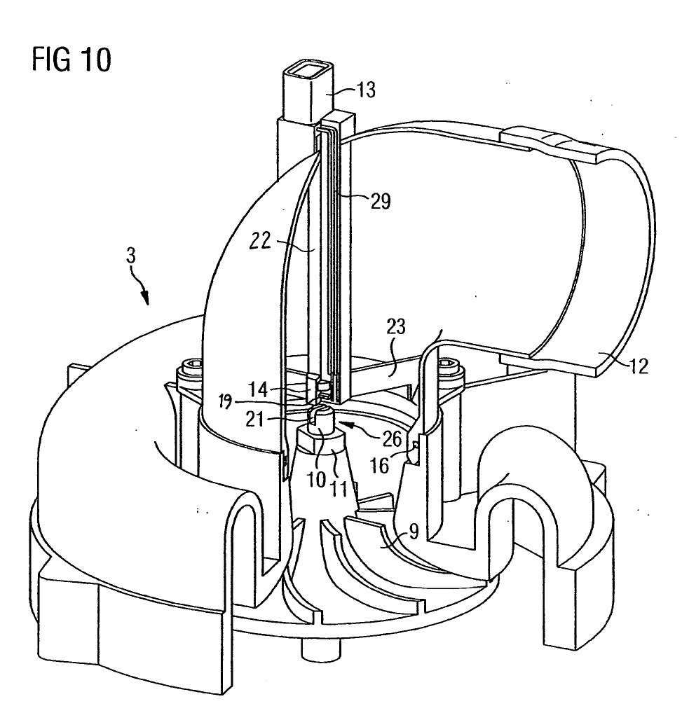

FIG. 10 shows the compressor in combination with a curved adapter,

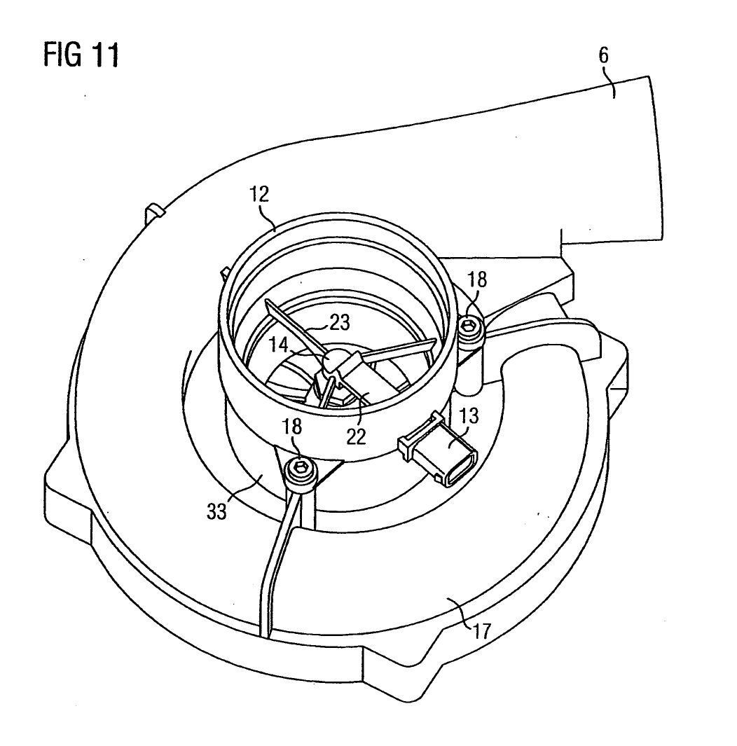

FIG. 11 shows a further exemplary embodiment,

FIG. 12 shows a partial section of the illustration in FIG. 11,

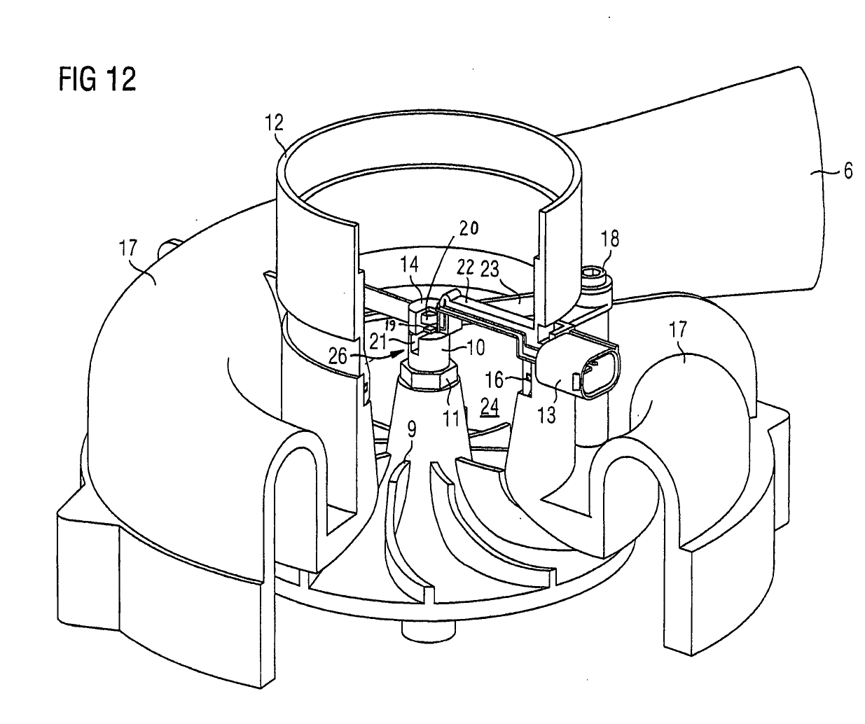

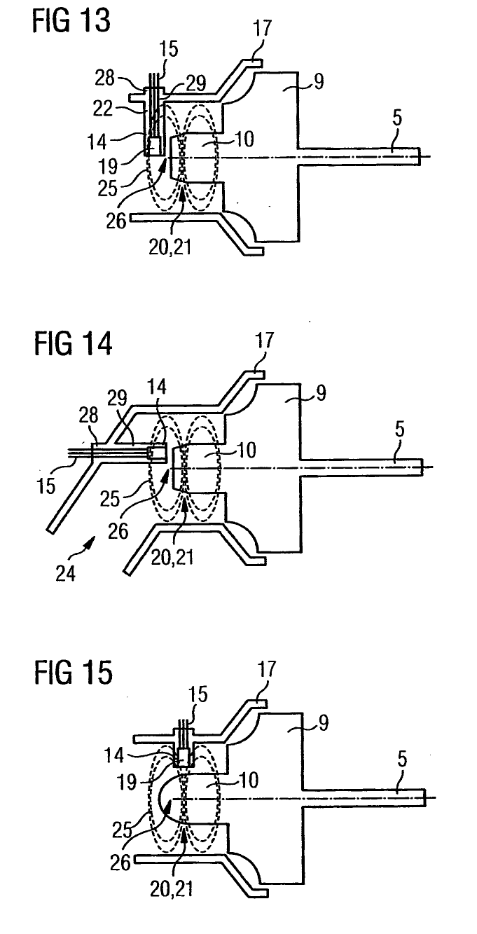

FIGS. 13-15 show schematic illustrations of the measuring principle,

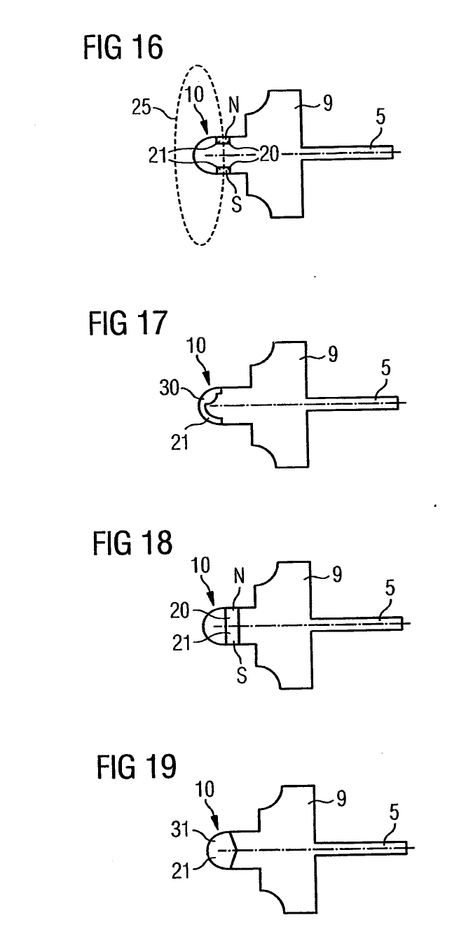

FIGS. 16-19 show various embodiments of the element for varying the magnetic field,

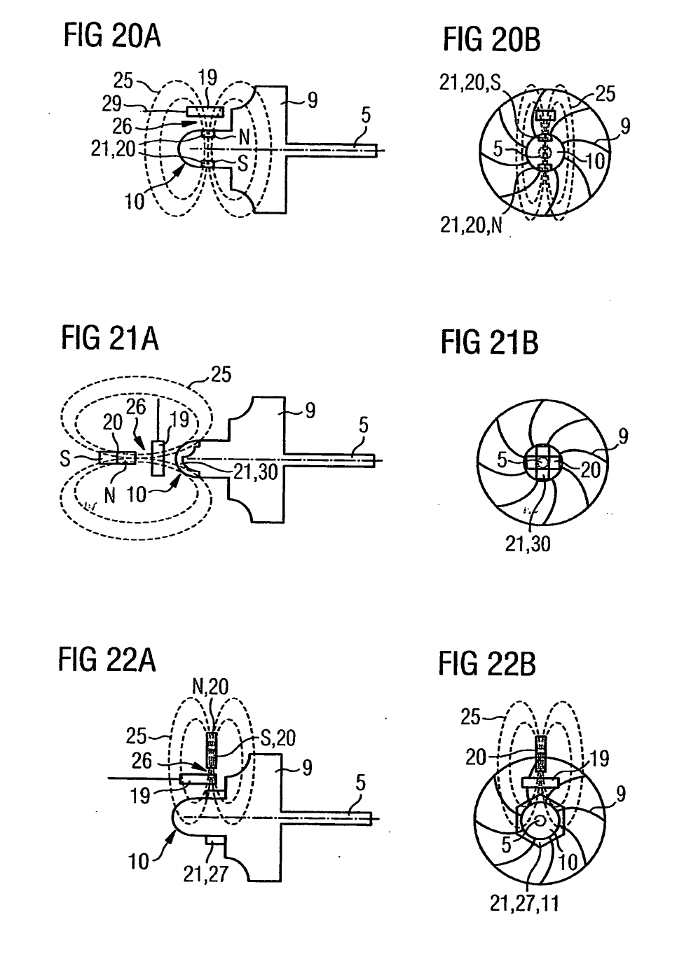

FIG. 20a shows a principle of the signal generation,

FIG. 20b shows the illustration in FIG. 20a rotated through 90 degrees,

FIG. 21a shows a further principle of the signal generation,

FIG. 21b shows the illustration in FIG. 21a rotated through 90 degrees,

FIG. 22a shows a third principle of the signal generation,

FIG. 22b shows the illustration in FIG. 22a rotated through 90 degrees,

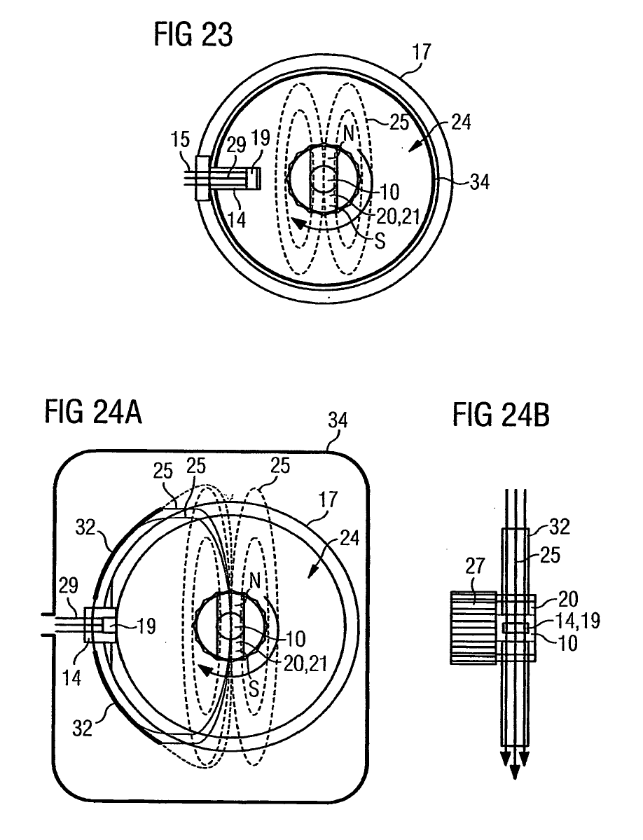

FIG. 23 shows a further embodiment,

FIG. 24a shows an embodiment in which the sensor element is integrated in the compressor casing,

FIG. 24b shows the illustration in FIG. 24a rotated through 90 degrees,

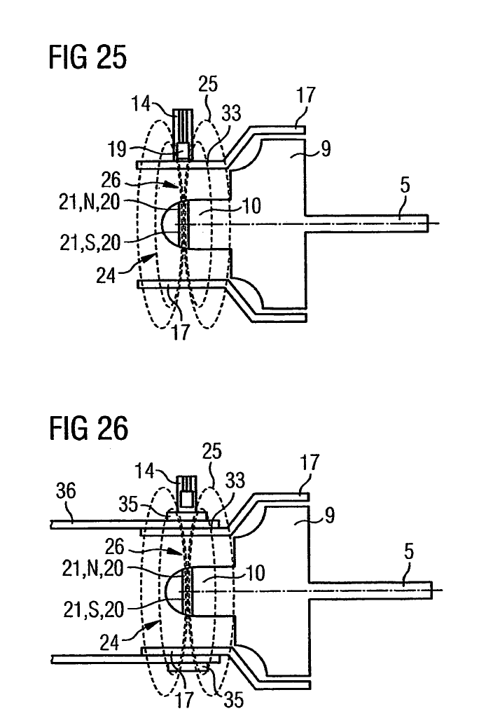

FIG. 25 shows an embodiment in which the sensor element is mounted on the outer wall of the compressor casing,

FIG. 26 shows an embodiment in which the sensor element is connected to a fastening system,

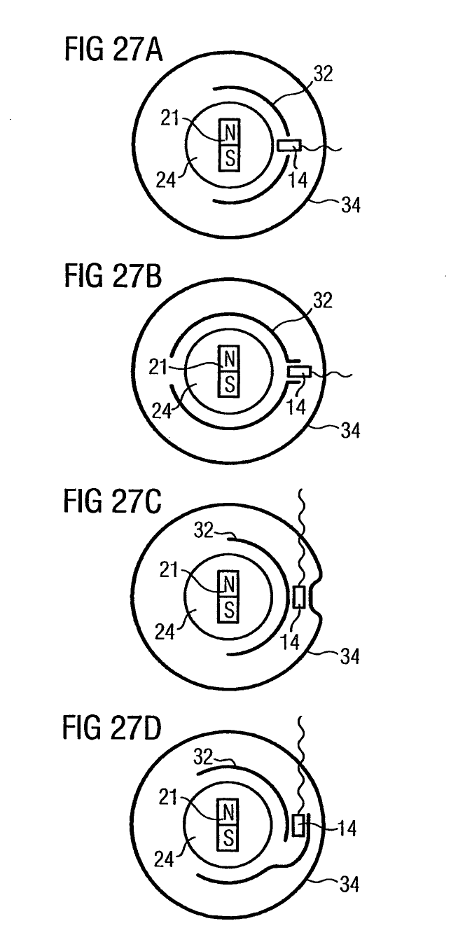

FIGS. 27a to d shows various embodiments of the flux-collecting body.

FIG. 1 shows a conventional exhaust-gas turbocharger 1 having a turbine 2 and a compressor 3. The compressor wheel 9 is rotatably mounted in the compressor 3 and connected to the turbocharger shaft 5. The turbocharger shaft 5 is also rotatably mounted and is connected at its other end to the turbine wheel 4. Hot exhaust gas from an internal combustion engine (not shown here) is let into the turbine 2 via the turbine inlet 7, the turbine wheel 4 being set in rotation. The exhaust-gas flow leaves the turbine 2 through the turbine outlet 8. The turbine wheel 4 is connected to the compressor 9 via the turbocharger shaft 5. The turbine 2 thus drives the compressor 3. Air is drawn into the compressor 3 through the air inlet 24 and compressed and is fed to the internal combustion engine via the air outlet 6.

FIG. 2 shows the turbine wheel 4, the turbocharger shaft 5 and the compressor wheel 9. As a rule, the turbine wheel 4 is made of a high-temperature austenitic nickel compound which is also suitable for the high temperatures when the turbocharger is used in spark-ignition engines. It is produced by a precision casting process and is connected to the turbocharger shaft 5, which as a rule is made of a highly quenched and tempered steel, for example by friction welding. The subassembly consisting of turbine wheel 4 and turbocharger shaft 5 is also referred to as the rotor or rotor assembly. The compressor wheel 9 is produced, for example, from an aluminum alloy, likewise by a precision casting process. The compressor wheel 9 is fastened to the compressor-side end 10 of the turbocharger shaft 5, as a rule by a fastening element 11. This fastening element 11 may be, for example, a cap nut 27, which firmly restrains the compressor wheel 9 together with a sealing bush, a bearing collar and a distance bush against the turbocharger shaft collar. The rotor assembly thus forms a fixed unit with the compressor wheel 9. Since the compressor wheel 9 is as a rule made of an aluminum alloy, it is problematical to determine the speed of the compressor wheel here using a measurement based on a change in the magnetic field.

FIG. 3 shows a compressor 3 having an air inlet 24 and an air outlet 6. Arranged at the air inlet 24 is an adapter 12 which is connected to the compressor casing 17, for example by a screw 18. Integrated in the adapter 12 is a connector housing, which together with a sensor element 19 forms a magnetic field sensor 14. The signals detected by the magnetic field sensor 14 can be fed to downstream electronics via the connecting pins 15 arranged in the connector housing 13.

FIG. 4 shows a partial section of the compressor 3 shown in FIG. 3. The compressor casing 17 can again be seen, which is connected to the adapter 12 by means of the screw 18. The cutaway compressor casing 17 exposes the compressor wheel 9 and the turbocharger shaft 5. A device 26 for detecting the speed of the turbocharger shaft 5 can be seen at the compressor-side end 10 of the turbocharger shaft 5. This device is to be described in more detail in FIG. 5.

FIG. 5 again shows the adapter 12 which is connected to the compressor casing 17 by means of the screw 18. The partial section through the adapter 12 now shows the magnetic field sensor 14, which in this exemplary embodiment contains a sensor element 19 and a magnet 20. The magnet 20 may be designed as both an electromagnet and a permanent magnet. The magnetic field produced by the magnet 20 continues through the sensor element 19 and reaches the element 21 for varying the magnetic field. The element 21 for varying the magnetic field is integrated in the compressor-side end 10 of the turbocharger shaft 5. In this exemplary embodiment, the element 21 for varying the magnetic field is realized as a slot in the compressor-side end 10 of the turbocharger shaft 5. Since the compressor-side end 10 of the turbocharger shaft 5 is made of magnetically conductive material (ferromagnetic/soft-magnetic material), the magnetic field produced by the magnet 20 is constantly varied during the rotation of the turbocharger shaft 5, and the variation in the magnetic field produced by the rotation of the turbocharger shaft 5 is detected by the sensor element 19 and converted into a signal that can be evaluated electrically. To this end, the sensor element 19 is arranged in the vicinity of the element 21 for varying the magnetic field. In this connection, the expression “in the vicinity” means a position of the sensor element 19 in which it can readily detect the magnetic field changes produced by the element 21 for varying the magnetic field in order to generate an electric signal (clearly above the electronic noise of the sensor element) that can be readily measured. This electric signal produced in the sensor element 19 as a function of the speed of the turbocharger shaft 5 is fed via electric conductors 29 to the connecting pins 15 in the connector housing 13. The electric signals that are generated by the sensor element 19 and that are in proportion to the speed of the turbocharger shaft 5 are thus available for further processing by the downstream vehicle electronics.

The adapter 12 known from FIG. 5 is shown again in more detail in FIG. 6. The magnetic field sensor 14 in which, according to the exemplary embodiment, the magnet 20 and the sensor element 19 is arranged can easily be seen. In addition, the magnetic field sensor 14 contains electric conductors 29 and a distance piece 22 which places the sensor element 19 precisely in front of or next to the element 21 for varying the magnetic field when the adapter 12 is connected to the compressor casing 17. The connector housing 13 accommodates the connecting pins 15 and is likewise connected to the adapter 12. To this end, the magnetic field sensor 14 and the adapter, for example, may be produced in one piece by the injection molding process. The electric signals generated by the sensor element 19 are made available to downstream evaluating electronics via the connecting pins 15. The distance piece 22 is kept relatively narrow and therefore reduces the cross section of the air inlet 24 of the compressor 3 only marginally.

FIG. 7 shows improved retention of the magnetic field sensor 14. Here, to retain the magnetic field sensor 14, at least one web 23 is formed in addition to the distance piece 22. The webs 23 reduce the cross section of the air inlet 24 of the compressor 3 only marginally, but contribute to increased stability of the construction consisting of adapter 12 and magnetic field sensor 14. The webs 23 can also easily be formed by the abovementioned injection molding process. Especially during pronounced vibrations, the magnetic field sensor 14 must be held exactly relative to the element 21 for varying the magnetic field, which is ensured by the webs 23.

FIG. 8 shows a partial section of the adapter 12 known from FIG. 7. The webs 23 which serve for the precise retention of the magnetic field sensor 14 can clearly be seen here. A seal 16, which can easily be seen in FIG. 8, is provided for sealing the adapter 12 at the connecting point to the compressor casing 17.

FIG. 9 shows a further possible embodiment of the invention. An adapter 12 having the magnetic field sensor 14 can be seen here too. However, the sensor element 19 is now arranged next to the element 21 for varying the magnetic field. The variation in the magnetic field is now produced by the fastening element 11, which may be designed, for example, as a nut produced from ferromagnetic material. This fastening element 11 now performs a double function, since it firstly connects the compressor wheel 9 to the turbocharger shaft 5 and, due to its arrangement at the compressor-side end of the turbocharger shaft 5, can be used for varying the magnetic field. The magnetic field to be varied is produced by the magnet 20, which is integrated in the magnetic field sensor 14. The sensor element 19 which detects the variation in the magnetic field and converts it into electric signals can also be seen.

A great advantage of the measurement of the speed of the turbocharger shaft 5 at the compressor-side end 10 of the turbocharger shaft 5 is the temperature prevailing here. Exhaust-gas turbochargers 1 are components which are subjected to high thermal loading and in which temperatures of up to 1000° C. arise. Measurements cannot be taken at these temperatures using known sensor elements 19, such as Hall sensors or magneto-resistive sensors for example. Substantially lower thermal loads occur at the compressor-side end 10 of the turbocharger shaft 5. As a rule, temperatures of about 140° in continuous operation and 160 to 170° after load peak occur in the air inlet 24 of a compressor 3. Due to the magnetic field sensor 14 arranged in the cold intake-air flow, its thermal load is considerably reduced compared with installation at other points of the exhaust-gas turbocharger.

FIG. 10 shows the compressor 3 in combination with a curved adapter 12. Here, too, the magnetic field sensor 14 is arranged in front of the compressor-side end 10 of the turbocharger shaft 5. The distance piece 22 now extends in the direction of the imaginary continuation of the turbocharger shaft 5. The connector housing 13 is located at the end of the distance piece 22. The electric conductors 29 which conduct the electric signals generated by the sensor element 19 to the connector housing 13 and the connecting pins 15 located therein can be seen in the distance piece 22. The curved adapter 12 can be advantageously used in particular when only a small construction space is available in the engine compartment, on account of which the conduits for the intake air have to be laid close to the turbocharger 1. Webs 23, which ensure especially accurate and low-vibration mounting of the magnetic field sensor 14, can also be seen in FIG. 10. The webs 23 and the distance piece 22 reduce the cross section of the air inlet 24 of the turbocharger 1 only to a small extent, as a result of which no output losses of the turbocharger 1 at all can be expected.

FIG. 11 shows a further exemplary embodiment in which the magnetic field sensor 14 is held by a tripod of webs 23. It can clearly be seen that the three webs 23 and the distance piece 22 affect the cross section of the air inlet 24 only to a very small extent. Due to the design of the webs 23, however, accurate positioning of the magnetic field sensor 14 in front of the compressor-side end 10 of the turbocharger shaft 5 is ensured. In addition, the webs 23 prevent movements of the magnetic field sensor 14 relative to the compressor-side end 10 of the turbocharger shaft 5.

FIG. 12 shows a partial section of the illustration in FIG. 11. The arrangement of the magnetic field sensor 14 in front of the element 21 for varying the magnetic field can clearly be seen in FIG. 12. In this example, the magnetic field is produced by a magnet 20 which is placed in the magnetic field sensor 14, the magnetic field being directed through the sensor element 19 and being varied during the rotation of the turbocharger shaft 5 by the element 21 for varying the magnetic field. The magnetic field is varied in proportion to the speed of the turbocharger shaft 5 and is detected and converted into electric signals by the sensor element 19. The electric signals are directed via electric conductors in the distance piece 22 to the connecting pins 15 in the connector housing 13, where they are available to downstream vehicle electronics for evaluation. Webs 23 hold the magnetic field sensor 14 firmly in the desired position.

Schematic illustrations of the measuring principle are shown in FIGS. 13 to 15.

In FIG. 13, a magnet 20 which serves as element 21 for varying the magnetic field is formed in the compressor-side end 10 of the turbocharger shaft 5. The variation in the magnetic field occurs when the turbocharger shaft 5 rotates and the magnetic field 25, now varying with respect to time, is detected in the sensor element 19. The magnetic field sensor 14 together with the sensor element 19, the electric conductors 29 in the distance piece 22 and the connecting pins 15 is designed here as a plug-in finger 28, which is merely inserted through the wall of the compressor casing 17 and fixed there. The design of the magnetic field sensor 14 as a plug-in finger 28 constitutes a very cost-effective embodiment of the magnetic field sensor 14 for the user, since only very slight changes are required to existing production turbochargers in order to be able to insert the magnetic field sensor 14 for speed measurement.

FIG. 14 shows a construction similar to that in FIG. 13, the compressor casing 17 now having a curved air inlet 24. Here, too, the magnetic field sensor 14 is designed as a plug-in finger 28, which is arranged along the imaginary extension of the turbocharger shaft 5. As already shown in some preceding figures, the magnetic field 25 is shown by means of field lines in FIG. 14, this magnetic field 25 running through the sensor element 19 and changing its field strength during the rotation of the turbocharger shaft 5, whereby electric signals are generated in the sensor element 19, which are in proportion to the speed of the turbocharger shaft 5. These electric signals are conducted via the electric conductors 29 to the connecting pins 15.

FIG. 15 shows a construction in which the magnetic field sensor 14 is also designed as a plug-in finger 28, which, however, is conceived in such a way that the sensor element 19 is held laterally next to the element 21 for varying the magnetic field and the compressor-side end 10 of the turbocharger shaft 5. Here, too, the field lines of the magnetic field 25 run through the sensor element 19, the magnetic field strength in the sensor element 19 being varied during the rotation of the turbocharger shaft 5 and a signal which is in proportion to the speed of the turbocharger shaft 5 being generated in the sensor element 19.

FIGS. 16 to 19 show various embodiments of the element 21 for varying the magnetic field 25. In each of these figures, the element 21 for varying the magnetic field 25 is arranged in the compressor-side end 10 of the turbocharger shaft 5.

In FIG. 16, the element 21 for varying the magnetic field 25 is designed in the form of two permanent magnets 20. The permanent magnets 20 are arranged in such a way that the south pole S of the top magnet faces the north pole N of the bottom magnet, from which a magnetic field 25 results which corresponds to that of a bar magnet having a north pole N and a south pole S.

In FIG. 17, the element for varying the magnetic field is designed as an inset 30 of magnetically conductive material. This inset 30 is integrated in a crescent-shaped manner in the compressor-side end 10 of the turbocharger shaft 5. In such a configuration, the magnetic field must be produced by a correspondingly positioned magnet 20 which directs the magnetic field lines through the compressor-side end 10 of the turbocharger shaft 5. A sensor element 19 arranged in this magnetic field then detects the variation in the magnetic field 25 during the rotation of the turbocharger shaft 5.

In FIG. 18, a bar magnet having a north pole N and a south pole S is arranged in the compressor-side end 10 of the turbocharger shaft 5. This bar magnet 20 is at the same time the element 21 for varying the magnetic field 25. The variation in the magnetic field 25 in the sensor element 19 (not shown here) is effected during the rotation of the turbocharger shaft 5.

FIG. 19 shows a further configuration of the element 21 for varying the magnetic field 25. Here, the element 21 for varying the magnetic field 25 is designed as a slot 31 in the compressor-side end 10 of the turbocharger shaft 5. For this purpose, the compressor-side end 10 of the turbocharger shaft 5 should be made of ferromagnetic (e.g. soft-magnetic) material. In a similar manner to FIG. 17, the magnetic field 25 is produced by a magnet 20 correspondingly arranged outside the compressor-side end 10 of the turbocharger shaft 5. The variation in the magnetic field is then effected during the rotation of the turbocharger shaft 5 by the slot 31 in the compressor-side end 10 of the turbocharger shaft 5.

The principle of the signal generation in the sensor element 19 by the element 21 for varying the magnetic field is shown in FIG. 20a. In this figure, the element 21 for varying the magnetic field is designed as a permanent magnet 20 integrated in the compressor-side end 10 of the turbocharger shaft 5. The magnetic field 25 produced by this magnet 20 is indicated by field lines. The field lines of the magnetic field 25 pass through the sensor element 19, the field strength of the magnetic field 25 varying in the sensor element 19 during the rotation of the turbocharger shaft 5, a factor which produces an electric signal in the sensor 19, this electric signal being in proportion to the speed of the turbocharger shaft 5. This electric signal can be made available to the downstream vehicle electronics via electric conductors 29.

FIG. 20b shows the illustration in FIG. 20a rotated through 90 degrees. The field lines emanating from the magnet 20, which here constitutes the element 21 for varying the magnetic field 25, pass through the sensor element 19 with a high field strength. If the compressor wheel 9 and the turbocharger shaft 5 are now rotated, the element 21 for varying the magnetic field 25 rotates with them, and the sensor element 19 is supplied with a lower field strength by the magnetic field 25. If the sensor element 19 is designed, for example, as a Hall sensor, a corresponding electric signal is obtained from this variation in field strength. If the sensor element 19 is designed as a magneto-resistive sensor, the variation in the gradient of the magnetic field 25 in the sensor element 19 produces the corresponding electric signal. In both cases, a signal that is in proportion to the speed of the turbocharger shaft 5 and can be correspondingly evaluated is generated.

FIG. 21a shows a configuration in which the element 21 for varying the magnetic field 25 is designed as an inset 30 of ferromagnetic (e.g. soft-magnetic) material in the compressor-side end 10 of the turbocharger shaft 5. The magnet 20 arranged frontally relative to the turbocharger shaft 5 produces a magnetic field 25. The north pole N and the south pole S are identified in the magnet 20. The magnetic field 25 runs through the sensor element 19. If the turbocharger shaft 5 is now rotated, the crescent-shaped inset 30 of ferromagnetic material rotates with it. The inset 30 of ferromagnetic material produces a variation of the magnetic field 25 in the sensor element 19. Both the field strength and the gradient of the magnetic field 25 in the sensor element 19 are changed by the inset 30 of ferromagnetic material. Thus both Hall elements and magneto-resistive elements are suitable as sensor element 19 for detecting the speed of the turbocharger shaft. Here, too, the illustration known from FIG. 21a is show rotated through 90 degrees in FIG. 21b. The element 21 for varying the magnetic field 25 can be seen, this element 21 being formed as a crescent-shaped inset 30 of ferromagnetic material in the compressor-side end 10 of the turbocharger shaft 5. The rotation of the turbocharger shaft 5 produces the variation in the magnetic field 25 on account of the arrangement of the element 21 at the compressor-side end 10 of the turbocharger shaft 5.

FIG. 22a shows the design of the element 21 for varying the magnetic field 25 as a nut 27 of ferromagnetic material. The nut 27 may be a “cap nut”. The nut 27 now performs a double function. Firstly, it presses the compressor wheel 9 against a seat of the turbocharger shaft 5 and therefore connects the compressor wheel 9 to the rotor assembly. Secondly, it varies the magnetic field 25, produced by the magnet 20, in the sensor element 19. This can be seen especially effectively in FIG. 22b. The nut 27 is both fastening element 11 for the compressor wheel 9 and element 21 for varying the magnetic field 25. The magnetic field 25 is produced by the magnet 20 and passes through the sensor element 19. Due to the polygonal design of the nut 27 of ferromagnetic material, both the field strength and the gradient of the magnetic field 25 in the sensor element 19 are varied. Both changes can be converted into electric signals by corresponding sensor elements.

FIG. 23 shows an embodiment in which the magnetic field sensor 14 together with its sensor element 19 is arranged to the side of the turbocharger shaft 5 in the air inlet of the compressor casing 17. The element 21 for varying the magnetic field 25 is designed here as a magnet 20 arranged in the compressor-side end 10 of the turbocharger shaft 5 or in the nut 27. If the magnet 20 produces a magnetic field 25 of sufficiently high field strength, the field strength excited in the sensor element 19 is sufficient to generate a sufficiently high electric signal which is in proportion to the speed of the turbocharger shaft 5.

FIG. 24a shows the embodiment known from FIG. 23, the sensor element 19 now being integrated in the compressor casing 17. If the magnetic field strength produced by the magnet 20 is not sufficient to readily generate sufficiently high electric signals in the sensor element 19 during the rotation of the turbocharger shaft 5, flux-concentrating bodies 32 which concentrate the magnetic flux produced by the magnet 20 and direct it to the sensor element 19 are arranged on the compressor casing 17. This is indicated diagrammatically in FIG. 24a by a larger number of magnetic field lines 25 being directed toward the flux-concentrating bodies 32. The magnetic flux thus collected is sufficient to generate sufficiently high electric signals in the sensor element 19, said electric signals being fed to downstream evaluating electronics via electric conductors 29. In order to keep away disturbances by external magnetic fields, a magnetic screen 34 is arranged inside the compressor casing 17. This magnetic screen encloses the sensor element 19 and the element 21 for varying the magnetic field 25. The magnetic screen 34 can also be advantageously integrated in the compressor casing 17.

FIG. 24b shows the arrangement from FIG. 24a rotated through 90 degrees. Shown here is a knurled nut 27 which may be designed as an element for varying the magnetic field. Alternatively, the element 21 for varying the magnetic field 25 is arranged in the compressor-side end 10 of the turbocharger shaft 5. A concentrated magnetic flux is fed to the sensor element 19 by the flux-concentrating bodies 32. As a result, the sensor element 19 can also be advantageously integrated in that part of the compressor casing 17 which is subjected to relatively low thermal loading. The magnetic field strength fed by the flux-concentrating bodies 32 is sufficient to generate sufficiently high electric signals in the sensor element 19 (signals which are clearly above the electrical noise). Here, too, a magnetic screen is provided which, unlike in FIG. 24a, also encloses the compressor casing 17. Thus the sensor element 19, the element 21 for varying the magnetic field 25 and the flux-concentrating bodies 32 are also enclosed by the magnetic screen 34.

In FIG. 25, the sensor element 19 is mounted on the outer wall 33 of the compressor casing 17. To this end, the sensor element 19 is integrated in a magnetic field sensor 14 which is adhesively bonded, for example, to the outer wall 33. If the magnet 20 produces a field of sufficient strength, a measurable variation in the magnetic field 25 is effected in the sensor element 19 during the rotation of the magnet 20 with the turbocharger shaft 5. Due to this arrangement, there is no need to interfere in any way with the compressor casing 17 and the cross section of the air inlet 24 is not reduced by the magnetic field sensor 14. This is especially advantageous during subsequent integration of the measuring principle in existing production turbochargers.

FIG. 26 shows an arrangement which is similar to that from FIG. 25, but in FIG. 26 an intake hose 36 is put onto the compressor casing 17, the combustion air to be compressed being fed through this intake hose 36 to the air inlet 24. A fastening system 35, which may designed, for example, as a hose clip, fastens the intake hose 36 to the compressor casing 17 in the region of the air inlet 24. The magnetic field sensor 14 is connected to the fastening system 35. The fastening system 35 therefore takes over the task of fastening the intake hose 36 and it carries the magnetic field sensor 14.

Various configurations of the flux-concentrating body 32 are shown in FIGS. 27a to 27d.

FIG. 27a shows the air inlet 24 and the element 21 for varying the magnetic field 25. The magnetic field 25 varied by the element 21 for varying the magnetic field 25 is directed to the magnetic field sensor 14 by the flux-concentrating body 32 and converted there into electric signals which correspond to the position of the element 21 for varying the magnetic field 25.

The element 21 for varying the magnetic field 25, the air inlet 24 and at least one flux-concentrating body 32 are also found in FIGS. 27b, c, d. In addition, the magnetic screen 34 screens external magnetic disturbance fields, so that the latter do not disturb the signal generated in the magnetic field sensor 14.

1.-24. (canceled)

25. An exhaust-gas turbocharger for an internal combustion engine, comprising:
a compressor having a compressor wheel rotatably mounted therein;
a turbine comprising a turbine wheel rotatably mounted therein;
a rotatably mounted turbocharger shaft mechanically connecting said compressor wheel to said turbine wheel; and
a device for detecting the speed of the turbocharger shaft, said device having an element for varying a magnetic field on or in a compressor-side end of said turbocharger shaft, the variation in the magnetic field being effected in relation to the speed of said turbocharger shaft, and a sensor element being arranged in a vicinity of said element for varying the magnetic field, said sensor element configured for detecting the variation in the magnetic field and converting it into electrically evaluatable signals, said sensor element being a Hall sensor element.

26. The exhaust-gas turbocharger of claim 25, wherein said sensor element is arranged at a location in an axial extension of said turbocharger shaft.

27. The exhaust-gas turbocharger of claim 25, wherein said sensor element is arranged adjacent the compressor-side end of said turbocharger shaft.

28. The exhaust-gas turbocharger of claim 25, wherein said compressor has a compressor casing defining an air inlet, an adapter mounted on said air inlet, and a sensor mounted on said adapter via a distance piece extending into said air inlet, said sensor element being integrated in said sensor.

29. The exhaust-gas turbocharger of claim 25, wherein said compressor has a compressor casing defining an air inlet, an adapter mounted on said air inlet, and a plug-in finger including a sensor and a distance piece, wherein said sensor element is integrated in said sensor, said plug-in finger is insertable as a plug into said air inlet through an aperture defined in said compressor casing.

30. The exhaust-gas turbocharger of claim 25, wherein said compressor has a compressor casing with an outer wall defining an air inlet and a sensor is mounted on said outer wall, said sensor element being integrated in said sensor.

31. The exhaust-gas turbocharger of claim 25, wherein said element for varying a magnetic field is a bar magnet.

32. The exhaust-gas turbocharger of claim 25, wherein said element for varying a magnetic field comprises two magnetic dipoles, a north pole (N) of a first one of said dipoles facing a south pole (S) of the second one of said dipoles.

33. The exhaust-gas turbocharger of claim 25, wherein said element for varying a magnetic field is a nut made of ferromagnetic material.

34. The exhaust-gas turbocharger of claim 33, wherein said nut is permanently magnetized.

35. The exhaust-gas turbocharger of claim 25, wherein said element for varying a magnetic field comprises a slot in the compressor-side end of said turbocharger shaft.

36. The exhaust-gas turbocharger of claim 25, further comprising at least one flux-concentrating body arranged such that said at least one flux-concentrating body collects a magnetic flux of the magnetic field and directs the magnetic flux toward said sensor element.

37. The exhaust-gas turbocharger of claim 25, further comprising a magnetic screen surrounding said element for varying the magnetic field and said sensor element, said magnetic screen screens said element for varying the magnetic field and said sensor element from external magnetic disturbance fields so that the external magnetic disturbance fields are prevented from disturbing the signals generated by said sensor element.

38. The exhaust-gas turbocharger of claim 36, further comprising a magnetic screen surrounding said element for varying the magnetic field, said sensor element, and said at least one flux-concentrating body, said magnetic screen screens said element for varying the magnetic field, said sensor element, and said flux-concentrating body from external magnetic disturbance fields so that the external magnetic disturbance fields are prevented from disturbing the signals generated by said sensor element.

39. The exhaust-gas turbocharger of claim 25, wherein said compressor has a compressor casing, and wherein at least part of said compressor casing comprises a magnetic screen configured for screening external magnetic disturbance fields.

40. The exhaust-gas turbocharger of claim 36, wherein a part of said at least one flux-concentrating body comprises a magnetic screen configured for screening external magnetic disturbance fields.

41. The exhaust-gas turbocharger of claim 36, wherein said compressor further comprises a fastening system for an intake hose, wherein said at least one flux-concentrating body is integrated in said fastening system.

42. The exhaust-gas turbocharger of claim 25, wherein said compressor further comprises a fastening system for an intake hose, wherein said sensor element is integrated in said fastening system.

43. The exhaust-gas turbocharger of claim 36, wherein said at least one flux-concentrating body is made of metal.

44. The exhaust-gas turbocharger of claim 43, wherein said at least one flux-concentrating body is made of ferrite.

45. The exhaust-gas turbocharger of claim 37, wherein said magnetic screen is made of metal.

46. The exhaust-gas turbocharger of claim 45, wherein said magnetic screen is made of ferrite.

47. The exhaust-gas turbocharger of claim 43, wherein said at least one flux-concentrating body is made of plastic-bonded ferrite.

48. The exhaust-gas turbocharger of claim 45, wherein said magnetic screen is made of plastic-bonded ferrite.

49. The exhaust-gas turbocharger of claim 37, wherein said sensor element is at least partially encapsulated in plastic.

50. The exhaust-gas turbocharger of claim 28, wherein said sensor is at least partially encapsulated in plastic.

51. The exhaust-gas turbocharger of claim 36, wherein said as least one flux-concentrating body is at least partially encapsulated in plastic.

52. The exhaust-gas turbocharger of claim 37, wherein said magnetic screen is at least partially encapsulated in plastic.

53. The exhaust-gas turbocharger of claim 42, wherein said fastening system is at least partially encapsulated in plastic.

54. An exhaust-gas turbocharger for an internal combustion engine, comprising:
a compressor having a compressor wheel rotatably mounted therein;
a turbine comprising a turbine wheel rotatably mounted therein;
a rotatably mounted turbocharger shaft mechanically connecting said compressor wheel to said turbine wheel; and
a device for detecting the speed of the turbocharger shaft, said device having an element for varying a magnetic field on or in a compressor-side end of said turbocharger shaft, the variation in the magnetic field being effected in relation to the speed of said turbocharger shaft, and a sensor element being arranged in a vicinity of said element for varying the magnetic field, said sensor element configured for detecting the variation in the magnetic field and converting it into electrically evaluatable signals, said sensor element being a magneto-resistive sensor element.
